(19) United States
(12) Patent Application Publication
(10) Pub. No.: US 2012/0320168 A1
(43) Pub. Date: Dec. 20, 2012

(54) METHOD AND APPARATUS FOR TRANSMISSION AND RECEPTION IN THE PROVISION OF A PLURALITY OF TRANSPORT INTERACTIVE 3DTV BROADCASTING SERVICES

(75) Inventors: Kug-Jin Yun, Daejeon (KR); Gwang-Soon Lee, Daejeon (KR); Jae-Hyun Seo, Daejeon (KR); Sung-Ik Park, Daejeon (KR); Hyun Lee, Daejeon (KR); Namho Hur, Daejeon (KR); Heung-Mook Kim, Daejeon (KR); Soo-In Lee, Daejeon (KR)

(73) Assignee: Electronics and Telecommunications Research Institute, Daejeon (KR)

(21) Appl. No.: 13/582,888

(22) PCT Filed: Mar. 7, 2011
(86) PCT No.: PCT/KR2011/001541

§ 371 Date: Sep. 5, 2012

(30) Foreign Application Priority Data
Mar. 5, 2010 (KR) 10-2010-0020135

(51) Int. Cl. H04N 13/04

(52) U.S. Cl. 348/51; 348/E13.075

(57) ABSTRACT

The present invention relates to a method and apparatus for providing a plurality of transport interactive 3DTV broadcasting services in the provision of higher definition 3D video service and 3D data service, while maintaining the compatibility with the existing digital TV broadcasts or 3DTV services. To this end, an input 3D video is encoded to generate a 3D additional video base stream and a 3D additional video enhanced stream. Engineer information for defining engineers, which includes 3D broadcasting service configuration information, is generated, and then an encoded 2D base video stream, an encoded audio stream, the encoded 3D additional video base stream and the engineer information are multiplexed and transmitted via a base layer. The 3D additional video enhanced stream is multiplexed and transmitted via an enhanced layer.

### CROSS-REFERENCES TO RELATED APPLICATIONS

The present application claims priority to Korean Patent Application No. 10-2010-0020135, filed on Mar. 5, 2010, and International Application No. PCT/KR2011/001541, filed on Mar. 7, 2011, respectively, which are incorporated herein by reference in their entirety.

### BACKGROUND OF THE INVENTION

1. Field of the Invention

Exemplary embodiments of the present invention relate to a transmitting and receiving method and a transmitting and receiving apparatus for providing a 3 dimension TV (3DTV) service, and more particularly, to a method and an apparatus for providing 3DTV service relating plural transmitting layer for providing higher quality of 3D video services and 3D data services while maintaining compatibility with existing digital TV (DTV) or 3 dimension (3DTV) services.

2. Description of Related Art

A television broadcasting system has been changed from a type of transmitting TV data in an analog form to a type of processing and transmitting TV data in a digital form. As described above, converting and transmitting video and audio signals in digital signals as well as TV is general trend.

Digital broadcasting using a motion picture experts group (hereinafter, referred to as “MPEG”) technology may transmit high definition programs in the same bandwidth as the existing analog broadcasting and may also transmit a plurality of standard definition programs to a single channel. Further, the digital broadcasting may provide several application services such as data broadcasting, interactive broadcasting, or the like. As described above, in order to provide a plurality of programs and several application services to a single transmission channel, a MPEG-2 transport stream (TS) generated from each service provider may be multiplexed on a single channel.

With the phenomenon, a method for providing 3 dimension videos using a digital video signal has been proposed in a recent broadcasting or movie system. In order to apply the method, a need exists a technology for providing higher-definition 3D video services and 3D data services while maintaining compatibility with the DTV or 3DTv services according to the related art.

In order for the related art to provide the 3D video services, that is, the stereoscopic video services to a user while maintaining compatibility with the existing DTV, a reference video (left video) is transmitted using a MPEG-codec and the 3D additional video (right video) is transmitted using any codec such as MPEG-4 Part 10 advanced vided coding (AVC). However, the related art transmits stereoscopic video only in the existing DTV transport bandwidth (for example, 19.39 Mbps) and thus, has a limitation in degrading image quality of 3D video.

### SUMMARY OF THE INVENTION

An embodiment of the present invention is directed to provide a transmitting and receiving method and a transmitting and receiving apparatus to a method and an apparatus for providing 3DTV service relating plural transmitting layer for transmitting auxiliary service information for higher quality of 3D video services and 3D data services by linking a basic layer with an enhancement layer while maintaining compatibility with existing digital TV (DTV) or 3 dimension (3DTV) services.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for providing a 3 dimensional television (3DTV) service relating plural transmitting layers, the method includes: coding an input 3d video to generate a 3D auxiliary video basic stream and a 3D auxiliary video enhancement stream; generating descriptor information defining a descriptor including 3D TV service configuring information; multiplexing a coded 2D reference video stream, a coded audio stream, the coded 3D auxiliary video basic stream, and the descriptor information to transmit a reference transport stream through a basic layer; and multiplexing the 3D auxiliary video enhancement stream to transmit a 3D enhancement transport stream through the basic layer and other layers.

In accordance with another embodiment of the present invention, a method for providing a 3DTV service relating plural transmitting layers, the method includes: generating a 3D object stream based on input object information; generating descriptor information defining a descriptor including 3DTV service configuring information; multiplexing a coded 2D reference video stream, a coded audio stream, and the descriptor information to transmit a reference transport stream through a basic layer; and multiplexing the 3D object stream to transmit a 3D object transport stream through the basic layer and other layers.

In accordance with another embodiment of the present invention, an apparatus for providing a 3DTV service relating plural transmitting layers, the transmitting apparatus includes: a coder configured to code an input 3d video to generate a 3D auxiliary video basic stream and a 3D auxiliary video enhancement stream; a descriptor information generator configured to generate descriptor information defining a descriptor including 3DTV broadcasting service configuring information; and a multiplexer configured to multiplex a coded 2D reference video stream, a coded audio stream, the coded 3D auxiliary video basic stream, and the descriptor information to transmit a reference transport stream through a basic layer and multiplexing the 3D auxiliary video enhancement stream to transmit a 3D enhancement transport stream through the basic layer and other layers.

In accordance with another embodiment of the present invention, an apparatus for providing a 3DTV service relating plural transmitting layers, the transmitting apparatus includes: a 3D object generator configured to generate a 3D object stream based on input object information; a descriptor information generator configured to generate descriptor information defining a descriptor including 3DTV service configuring information; and a multiplexer configured to multiplex a coded 2D reference video stream, a coded audio stream, and the descriptor information to transmit a reference transport stream through a basic layer and multiplexing the 3D object stream to transmit a 3D object transport stream through the basic layer and other layers.

In accordance with another embodiment of the present invention, an apparatus for providing a 3DTV service relating plural transmitting layers, the apparatus includes: a demodulator configured to demodulate a first transport stream transferred through a basic layer and a second transport stream transferred through layers different from the basic layer; a demultiplexer configured to receive the first and second transport streams from the demodulator, demultiplex program specific information included in each of the first and second transport streams to transfer the demultiplexed program specific information to a program specific information (PSI) analyzer, and demultiplex a reference video stream, a 3D auxiliary video basic stream, and an audio stream from the first transport stream and a 3D auxiliary video enhancement stream from the second transport stream, based on an analyzing result transferred from the PSI analyzer; a PSI analyzer configured to receive and analyze the PSI from the demultiplexer; and a plurality of decoders configured to decod the demultiplexed reference video stream, 3D auxiliary video basic stream, 3D auxiliary video enhancement stream, and audio stream.

In accordance with another embodiment of the present invention, a method for providing a 3DTV service relating plural transmitting layers, the receiving method includes: demodulating a first transport stream transferred through a basic layer and a second transport stream transferred through layers different from the basic layer, respectively; analyzing PSI included in each of the first and second transport streams; demultiplexing a reference video stream, a 3D auxiliary video basic stream, and an audio stream from the first transport stream and a 3D auxiliary video enhancement stream from the second transport stream, based on an analyzing result of the PSI included in each of the first and second transport streams; and decoding the demultiplexed reference video stream, 3D auxiliary video basic stream, 3D auxiliary video enhancement stream, and audio stream, respectively.

In accordance with another embodiment of the present invention, an apparatus for providing a 3DTV service relating plural transmitting layers, the apparatus includes: a demodulator configured to demodulate a first transport stream transferred through a basic layer and a second transport stream transferred through layers different from the basic layer; a demultiplexer configured to receive the first and second transport streams from the demodulator, demultiplex PSI included in each of the first and second transport streams to transfer the demultiplexed PSI to a PSI analyzer, and demultiplex a reference video stream and an audio stream from the first transport stream and a 3D object stream from the second transport stream, based on an analyzing result transferred from the PSI analyzer; a PSI analyzer configured to receive and analyze the PSI from the demultiplexer; and a plurality of decoders configured to decode the demultiplexed reference video stream, 3D object stream, and audio stream.

In accordance with another embodiment of the present invention, a method for providing a 3DTV service relating plural transmitting layers, the method includes: demodulating a first transport stream transferred through a basic layer and a second transport stream transferred through layers different from the basic layer, respectively; analyzing PSI included in each of the first and second transport streams; demultiplexing a reference video stream and an audio stream from the first transport stream and a 3D object stream from the second transport stream, based on an analyzing result of the PSI included in each of the first and second transport streams; and decoding the demultiplexed reference video stream, 3D object stream, and audio stream, respectively.

A first program map table included in the first transport stream and a second program map table included in the second transport stream may include relationship information between programs linked with each other.

A 3D service descriptor included in the first program map table may include an identifier value indicating the 3D service descriptor, the entire length of the 3D service descriptor, and information for distinguishing a 3D service and a 2D service from each other and an auxiliary service descriptor included in the second program map table may include an identifier value indicating the auxiliary service descriptor, the entire length of the auxiliary service descriptor, and information indicating a state linked with the program included in the reference transport stream.

### BRIEF DESCRIPTION OF THE DRAWINGS

FIG. 1 is a functional block diagram of a 3DTV transmitting system for 3 dimension video services based on hierarchy modulation according to an embodiment of the present invention.

FIG. 2 is a diagram for describing an operation of a transmitting system of FIG. 1 according to the embodiment of the present invention.

FIG. 3 is a functional block diagram of a 3DTV transport stream for 3 dimension data services based on hierarchy modulation according to an embodiment of the present invention.

FIG. 4 is a diagram showing a configuration example of a transport stream of a basic layer and an enhancement layer for 3 dimension video services according to the embodiment of the present invention.

FIG. 5 is a diagram showing a configuration example of a transport stream of a basic layer and an enhancement layer for 3 dimension data services according to the embodiment of the present invention.

FIG. 6 is a configuration diagram of a receiving apparatus for 3D video services according to the embodiment of the present invention.

FIG. 7 is a block configuration diagram of a receiving apparatus for 3D data services according to the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

An embodiment of the present invention relates to a 3DTv service technology relating plural transmitting layers. In exemplary embodiments of the present invention, a 3D video service means stereoscopic video services providing a 3 dimension effect to a user based on left and right videos, wherein the 3D data service means providing only specific objects such as images, texts, or the like, on a mono video in the 3D type.

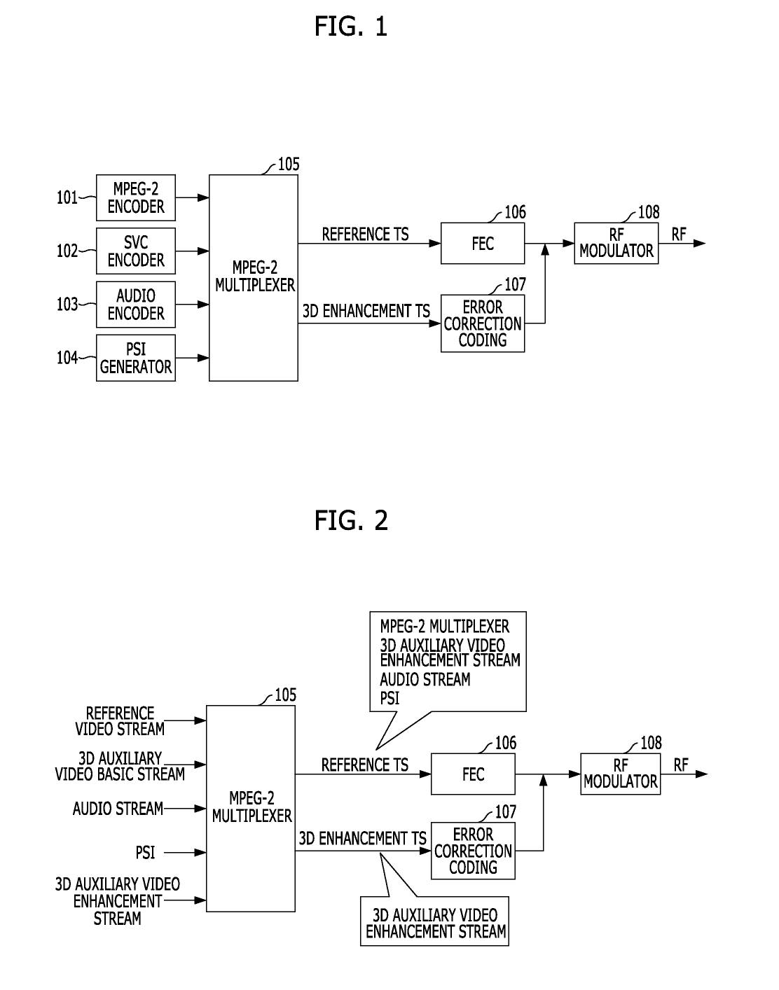

FIG. 1 is a functional block diagram of a 3DTV transmitting system for 3 dimension video services based on hierarchy modulation according to an embodiment of the present invention and FIG. 2 is a diagram for describing an operation of a transmitting system of FIG. 1 according to the embodiment of the present invention.

FIG. 1 shows a transport stream for providing higher quality of 3DTv services than the existing 3DTV services by additionally transmitting additional information for 3D additional videos while providing compatibility with the existing DTV or 3DTV terminal.

Referring to FIG. 1, in order to provide the compatibility with the existing DTV (for example, terrestrial broadcasting, cable broadcasting, satellite broadcasting, or the like), the reference videos (left video or right video) are coded through an MPEG-2 encoder 101 and for the 3D additional videos, are coded through a scalable video coding (SVC) encoder 102. The SVC technology may provide separate additional streams while providing the compatibility with the AVC technology. Therefore, the exemplary embodiment of the present invention using the SVC technology can provide the 3DTV services even in the existing 3DTV receiver to which the MPEG-2 encoder and the AVC technology are applied and the 3DTV receiver to which the MPEG-2 encoder and the SVC technology are applied can provide the higher quality of 3DTV services.

Referring to FIG. 2, the MPEG-2 encoder 101 codes the reference video such as a left video or a right video to output the reference video stream. The audio encoder 103 codes the input audio signal to output the audio stream. In addition, a program specific information (PSI) generator 104 defines a descriptor including the 3 dimension broadcasting service configuration information to output the program specific information (PSI). As described above, the reference video stream, the audio stream, and the program specific information (PSI) show the existing DTV standard based coding stream and program information so as to provide the compatibility with the existing DTV receiver. In this case, the PSI generator 104 may further include a program service information protocol (PSIP)/service information (SI) generator according to the broadcasting standard. In the existing 2D digital broadcasting system standard, the broadcasting protocol information showing the broadcasting configuration is configured by the PSI and the terrestrial PSIP in the case of the ATSC, is configured by the PSI and the SI in the case of the DVB-S, and is configured by the PSI and the cable PSIP in the case of OpenCable. At this time, the case of the ATSC in the need of the broadcasting protocol information, the PSI is selective and the PSIP is essential, in the case of the DVB-S, the PSI and the SI are essential, and in the case of the OpenCable, the PSI is essential and the PSIP is selective.

The SVC encoder 102 encodes the input 3 dimension video information through the scalable video coding (SVC), and outputs the 3D additional video basic stream and the 3D additional video enhancement stream. The 3D additional video basic stream represents the basic layer stream output by the scalable video coding (SVC) so as to provide the compatibility (compatibility with the existing AVC codec) with the existing 3DTV receiver and 3DTV services and the 3D additional video enhancement stream represents the extra stream for providing the higher quality of 3DTV services than the existing 3DTV service.

A MPEG-2 multiplexer 105 multiplexes the reference video stream, the audio stream, the PSI and 3D additional video basic stream within the existing DTV bandwidth to output a reference transport stream (TS) through the basic layer. Further, the reference transport stream (TS) is subjected to forward error correction (FEC) coding (106). The reference transport stream subjected to the error correction coding is RF-modulated and transmitted by an RF modulation unit 108 so as to maintain the compatibility with the existing DTV or 3DTV receiver.

Meanwhile, the 3D additional video enhancement stream is multiplexed into separate transport stream (3D enhancement TS) different from the basic layer. Further, the 3D enhancement transport stream (TS) is subjected to the forward error correction (FEC) coding or another error correction coding (107) and the error correction coded 3D enhancement transport stream (TS) are RF-modulated and transmitted.

The exemplary embodiment of the present invention as described above transmits the 3D additional video enhancement stream separately from the reference transport stream while having the compatibility with the 3DTV service in addition to the DTV service, thereby providing the higher quality of 3DTV services. In addition, in FIG. 1, even when the MPEG-2 encoder is changed into other codecs such as AVC, or the like, the digital broadcasting platform based 3DTV service such as IPTV, satellite broadcasting that are being currently serviced can be performed. In addition, although the exemplary embodiment of the present invention describes the case in which the 3D video is coded using the SVC encoder, but can be applied even to the case in which other coding methods may be used. In addition, even though the exemplary embodiment of the present invention describes the case in which the 3D additional video enhancement stream is transmitted through the enhancement layer, it is apparent to those skilled in the art that the 3D additional video enhancement stream may be transmitted through any layers different from the basic layer.

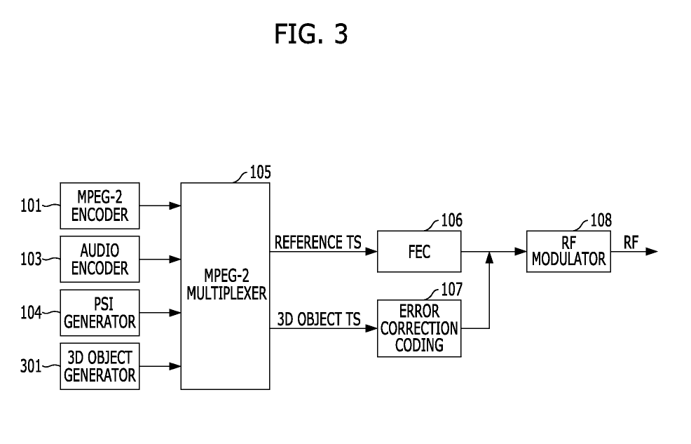

FIG. 3 is a functional block diagram of a 3DTV transport stream for 3 dimension data services based on hierarchy modulation according to an embodiment of the present invention.

The 3D data service use the existing DTV standard as it is and uses separately transmitted 3D objects (for example, images, texts, graphics, animation, or the like) to providing 3D services relating program or non-relating program. The 3D data service has the advantages in that the system complexity and the required transmission rate is less than the 3D video service.

Referring to FIG. 3, in order to provide compatibility with the existing DTV (terrestrial broadcasting, cable broadcasting, satellite broadcasting, or the like), video is coded through the MPEG-2 encoder 101, audio is coded through the audio encoder 103, the PSI is generated through the PSI generator 104 and is transmitted through the existing DTV standard based multiplexing and modulation method.

Further, the 3D object generated by a 3D object generator 301 is transmitted by a separate transport stream (3D object TS). The 3D object may be transmitted by being multiplexed into the transport stream (TS) but may be transmitted by a separate transmission format such as a file, or the like. The 3DTV receiver to which the embodiment of the present invention is applied can additionally receive and reproduce the 3D object, as compared with the existing DTV services. In addition, the 3D objects can be transmitted to the receiver in real time or non-real time and can be serviced by a broadcasting program relating and non-relating type.

Referring to FIG. 3, the MPEG-2 encoder 101 codes the input video to output the reference video stream as described with reference to FIG. 1. The audio encoder 103 codes the input audio signal to output the audio stream. In addition, the PSI generator 104 defines a descriptor including the 3 dimension broadcasting service configuration information to output the program specific information (PSI). The MPEG-2 multiplexer 105 multiplexes the reference video stream and the audio stream and the PSI within the existing DTV bandwidth to output a reference transport stream (TS). Further, the reference transport stream (TS) is subjected to forward error correction (FEC) coding (106). The reference transport stream subjected to the error correction coding is RF-modulated and transmitted by an RF modulation unit 108 so as to maintain the compatibility with the existing DTV or 3DTV receiver.

Meanwhile, the 3D object generated by a 3D object generator 301 is multiplexed into a separate transport stream (3D object TS) by the MPEG-2 multiplexer 105. Further, the 3D object transport stream (TS) is subjected to the forward error correction (FEC) coding or another error correction coding (107) and the error correction coded 3D object transport stream (TS) are RF-modulated and transmitted.

According to the embodiment of the present invention as described above, a separate program map table (PMT) may be included in the 3D enhancement transport stream (TS) and the 3D object transport stream (TS). The separate program map table (PMT) within the 3D enhancement transport stream (TS) and the 3D object transport stream (TS) includes the information representing correlation with the program map table (PMT) information within the PSI within the reference transport stream (TS).

The following Table 1 represents an example of a descriptor within the program specific information (PSI) for providing the auxiliary services through the basic layer according to the embodiment of the present invention.

Referring to Table 1, descriptor_tag has an identifier value informing that the descriptor_tag is a 3D service descriptor. Descriptor_length represents the entire length of the immediately next fields. StereoMono_service_flag is a value for distinguishing whether the corresponding program is a general two-dimensional service or 3 dimension service and represents the 3 dimension service when StereoMono_service_flag=1. In the case of the 3D service, the type of the service is divided according to a value of 3D_service_type. For example, when 3D_service_type is “0000”, “reserved” may be represented, when 3D_service_type is “0001”, the 3D video service may be represented, when 3D_service_type is “0010”, the 3D audio service may be represented, when 3D_service_type is “0011”, the 3D data service relating program may be represented, when 3D_service_type is “0100”, the program independent 3D data service may be represented, and when 3D_service_type is “0101”, the 3D non-real time service may be represented. Composition_type represents left and right double videos or represents a 3D video format such as a side-by-side manner. Further, the descriptor within the program specific information may include other necessary attributes.

TABLE 1
syntax

```
3D_service_descriptor( ) {
    descriptor_tag
    descriptor_length
  StereoMono_service_flag
  If (StereoMono_service_flag) {
    3D_service_type
    composition_type
      :
  }
  :
}
```

In addition, the following Table 2 represents an example of the auxiliary service descriptor for providing the auxiliary service through the enhancement layer according to the embodiment of the present invention.

Referring to Table 2, descriptor_tag has an identifier value informing that the descriptor_tag is an auxiliary service descriptor. Descriptor_length represents the entire length of the immediately next fields. auxiliary_service_type is to define a type of a service additionally provided through the enhancement layer together with the service provided through the basic layer. For example, when auxiliary_service_type is “0x00”, “reserved” may be represented, when auxiliary_service_type is “0x01”, “0x02” may be represented, when auxiliary_service_type “0x03”, the data service relating program may be represented, when auxiliary_service_type is “0x04”, a program independent data service may be represented, when auxiliary_service_type is “0x05”, the 3D data service relating program may be represented, when auxiliary_service_type “0x06”, the program independent 3D data service may be represented, when auxiliary_service_type is “0x08”, the non-real time service may be represented, and when auxiliary_service_type is “0x09”, the non-real time 3D service may be represented.

TABLE 2

| syntax | Remarks |
|---|---|
| Auxiliary_service_descriptor( ) | Other layer services |
| { | Positional Information |

descriptor_tag
descriptor_length

auxiliary_service_type
service_dependency_flag
If (service_dependency_flag)

{

```
  dependency_TSID
  :
```

```
  }
  :
}
```

service_dependency_flag represents whether the services provided through the corresponding program within the transport stream (TS) of the basic layer and the enhancement layer are linked with each other. The correlation between the programs within the transport stream of the basic layer and the enhancement layer is defined by the program map table (PMT).

service_dependency_flag that is 1 represents that the specific programs of the basic layer and the enhancement layer are linked with each other and describes the service positional information of the linked opponent layer. For example, dependency_TSID indicates an opponent transport_stream_id. If program_numbers within the corresponding program map table (PMT) of the transport stream of the basic layer and the enhancement layer are different from each other, the specific program is indicated by adding program_number of the opponent PMT when service_dependency_flag=1. However, if the program numbers within the corresponding PMT of the basic layer and enhancement layer transport stream are the same, there is no need to add the separate program_number. In addition, as the linked service positional information, various factors such as source_id described in a program and system information protocol (PSIP), or the like, may be used. The detailed content thereof refers to advanced television systems committee (ATSC) standard A/65C.

In Table 2, the auxiliary service descriptor may be included in the descriptor immediately after Program_info_length within the program map table (PMT) of the transport stream of the basic layer or the enhancement layer. In order to complete the reverse compatibility and make the identification of the enhancement layer transport stream easy, the auxiliary service descriptor may be advantageously included in the enhancement layer transport stream.

When the auxiliary service descriptor is included in the enhancement layer transport stream, service_dependency_flag represents whether the service provided through the corresponding program of the enhancement layer transport stream depends on the basic layer. If service_dependency_flag is 1, the specific program of the enhancement layer transport stream depends on the specific program of the basic layer and the dependency_TSID indicates transport_stream_id of the basic layer transport stream. If the program_numbers within the corresponding PMT of the basic layer and the enhancement layer are different from each other, the specific program of the basic layer is indicated by adding the program_number of the basic layer PMT when service_dependency_flag is 1. However, when the program_numbers within the corresponding PMT of the basic layer and the enhancement layer are the same, the specific program of the basic layer may be indicated without adding the separate program_number.

The specific information for the channel and the service in the ATSC may be transmitted through the program service information protocol (PSIP). Among those, the attributes of the virtual channels provided by each program are described in a virtual channel table (VCT) and the event information for each time is described in an event information table (EIT). Therefore, when the PSIP information is included in the transport stream of the enhancement layer, the 3D service descriptor of Table 1 and the auxiliary service descriptor of Table 2 are each inserted into a descriptor loop within the VCT or the EIT of the basic layer transport stream and the enhancement layer transport stream.

In this case, service_type attribute of the virtual channel is previously defined within the VCT and thus, the 3D_serivce_type of the 3D service descriptor and the auxiliary_service_type of the auxiliary service descriptor will be implemented by adding a value for each service type to the service_type value of the existing VCT as described above, without being separately defined. The contents thereof refers to ATSC standard A/65C sections 6.3 and 6.5.

The following Table 3 shows an example of SVC_video-descriptor that includes the information for the video basic stream at the time of coding the 3D auxiliary video with the SVC codec.

TABLE 3
Syntax

```
SVC_video_descriptor( ) {
  descriptor_tag
  descriptor_length
  hierarchy_type
  layer_id
  max_quality_id
  :
}
```

descriptor_tag has an identifier value informing that the descriptor_tag is enhancement_video_descriptor. Descriptor_length represents the entire length of the immediately next fields. scalability_type represents a type of scalability at the time of coding. The embodiment of the present invention needs SNR Scalability (scalability_type=2) using image quality, multi-view profile (scalability_type=8) for applying mutli-view video, or the like.

layer_id is a hierarchy identifier of the SVC enhancement layer and the basic layer is designated as ‘0’ and the enhancement layer is increased from ‘1’. Therefore, in the embodiment of the present invention, the 3D auxiliary video enhancement stream has a value of ‘1’. When the multi-view profile is applied, layer_id is increased according to the number of views.

max_quality_id represents the level of image quality (defined in SVC NAL unit header extension) of the enhancement layer video, which is a necessary value since the embodiment of the present invention uses the SNR scalability. In addition, various attributes associated with the SVC may be added.

The embodiment of the present invention provides various service configurations such as the 3D video service, the 3D data service, the non-real time service, or the like, according to values of StereoMono_service_flag, 3D_service_type, and auxiliary_service_type that are described within the PMT of the basic layer and enhancement layer transport stream.

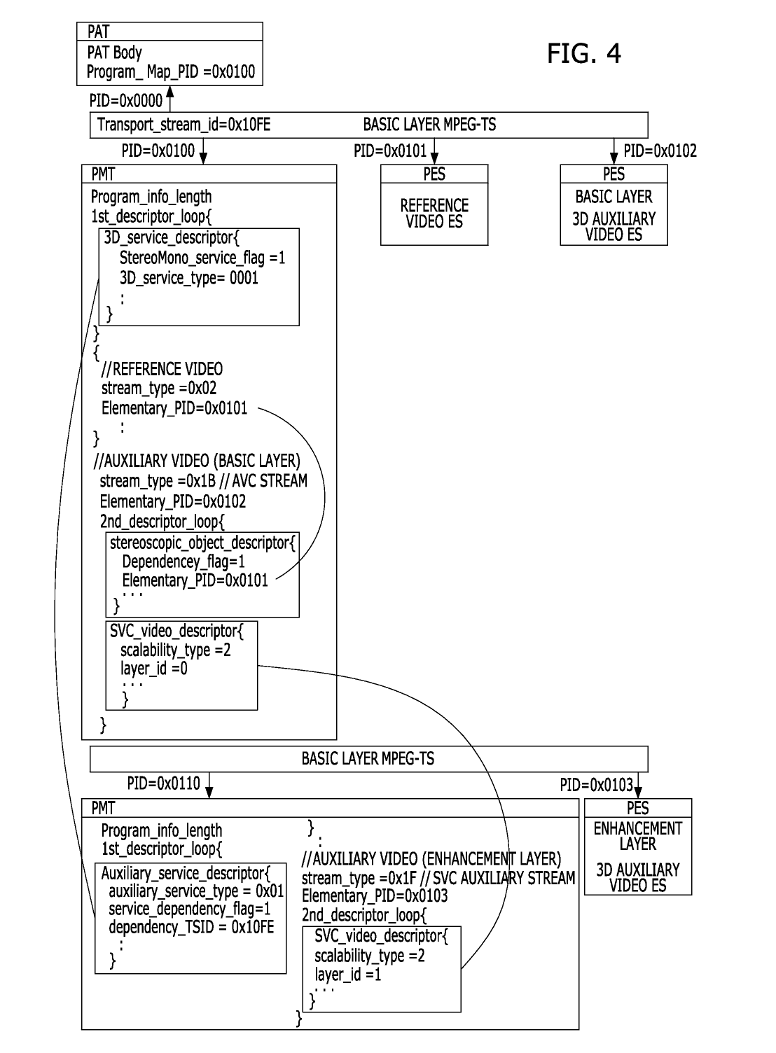

FIG. 4 shows an example of the configuration of the program map table (PMT) showing the correlation of the program included in the basic layer and enhancement layer transport stream according to the embodiment of the present invention. FIG. 4 illustrates an example of the case of the 3D video service according to the embodiment of the present invention.

3D_service_descriptor within the first descriptor loop within the basic layer transport stream PMT is set to be StereoMono_service_flag=1 and 3D_service_type=0001 to represent that the present program provides the 3D video service. In connection with this, Auxiliary_service_descriptor within the first descriptor loop within the program map table (PMT) of the enhancement layer transport stream is set to be auxiliary_service_type=0x01, service_dependency_flag=1, and dependency_TSID=0x10FE (transport stream id of the basic layer transport stream) representing the video service and thus, the corresponding service is linked with the basic layer to represent the additional video service. In addition, since stream_type=0x1F (SVC additional stream) is set within the program map table (PMT) of the enhancement layer transport stream and layer_id=1, scalability_type=2 (SNR scalability) is set within the SVC_video_descriptor of the second descriptor loop and stream_type=0x1B (AVC stream) is set within the PMT of the basic layer transport stream and layer_id is set to be 0 within SVC_video_descriptor of the second descriptor loop, the service provided through the basic layer and enhancement layer transport stream is the 3D video service described in FIG. 2 and represents the improved image quality of the 3D auxiliary video.

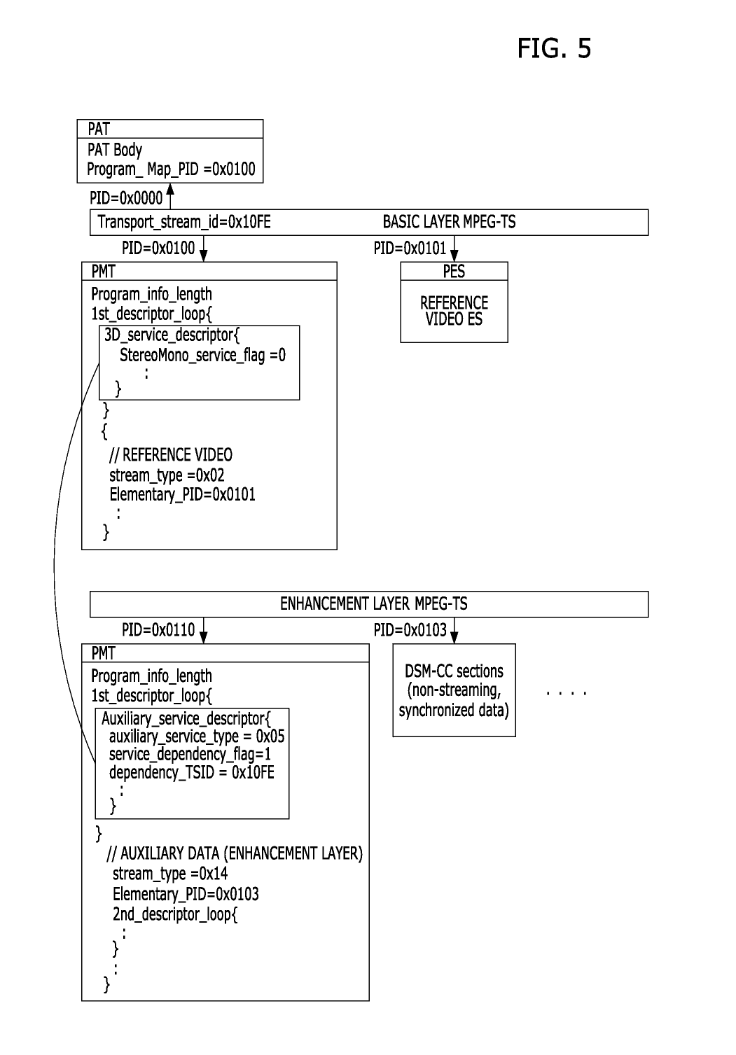

FIG. 5 shows an example of the configuration of the program map table (PMT) showing the correlation of the program included in the basic layer and enhancement layer transport stream according to the embodiment of the present invention and thus, represents the case of the 3D data service relating program.

StereoMono_service_flag=0 is set within 3D_service_descriptor within the first descriptor loop within the PMT of the basic layer transport stream and thus, the present program provides the 2D video service, but auxiliary_service_type=0x05 (3D data service relating program), service_dependency_flag=1, and dependency_TSID=0x10FE (transport_stream_id of basic layer transport stream) is set within Auxiliary_service_descriptor within the first descriptor loop within the linked enhancement layer transport stream PMT, such that the corresponding service is linked with the basic layer to provide the additional 3D data service relating program. In addition, stream_type=0x14 (DSM-CC sections containing non-streaming, synchronized data) is set in the second descriptor loop and the 3D objects such as images, texts, graphics, or the like, are downloaded through the corresponding packet data (refer to ATSC A/92).

Therefore, in the embodiment of the present invention, the terminal capable of decoding only the basic layer transport stream receives general two-dimensional services. On the other hand, the terminal capable of simultaneously decoding the basic layer and enhancement layer transport stream by demodulating the basic layer modulation signal can reproduce the 3D object data linked therewith on the two-dimensional video.

Next, the receiving apparatus and the receiving method according to the embodiment of the present invention will be described.

The receiving method for 3D video service according to the embodiment of the present invention receives the transport stream through the basic layer and the transport stream through a layer (for example, the enhancement layer) different from the basic layer to analyze the program map table included in the basic layer transport stream and the enhancement layer transport stream. Further, the 3D video service is demultiplexed into the reference video stream, the 3D auxiliary video basic stream, the 3D auxiliary video enhancement stream, and the audio stream based on the analysis results of the program map table included in the basic layer and enhancement layer transport stream. Further, the demultiplexed reference video stream is decoded, the 3D auxiliary video basic stream and the 3D auxiliary video enhancement stream are decoded, and the audio stream is decoded.

In addition, the receiving method for 3D data service according to the embodiment of the present invention receives the transport stream through the basic layer and the transport stream through a layer (for example, the enhancement layer) different from the basic layer to analyze the program map table included in the basic layer transport stream and the enhancement layer transport stream. Further, the 3D video service is demultiplexed into the reference video stream, the 3D object stream, and the audio stream based on the analysis results of the program map table included in the basic layer and enhancement layer transport stream. Further, the demultiplexed reference video stream is decoded, the 3D object stream is decoded, and the audio stream is decoded.

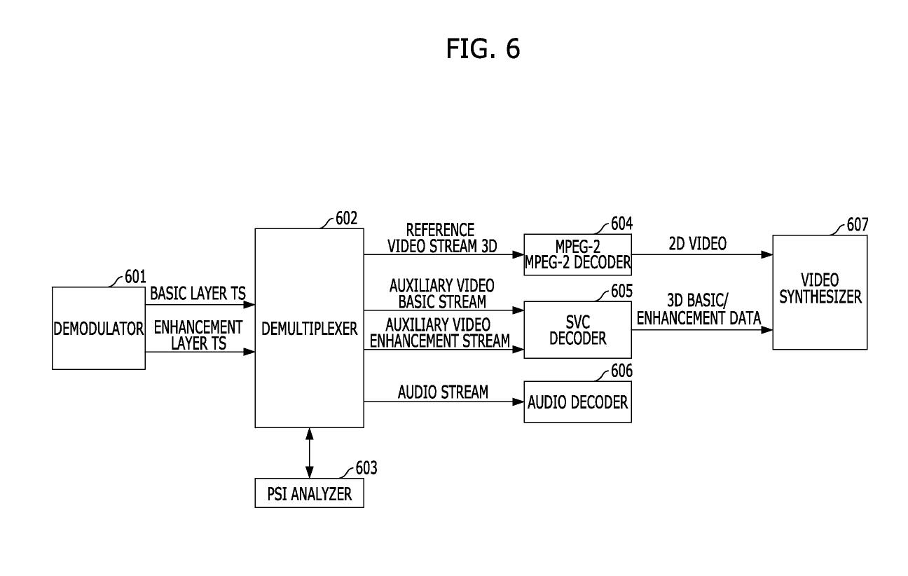

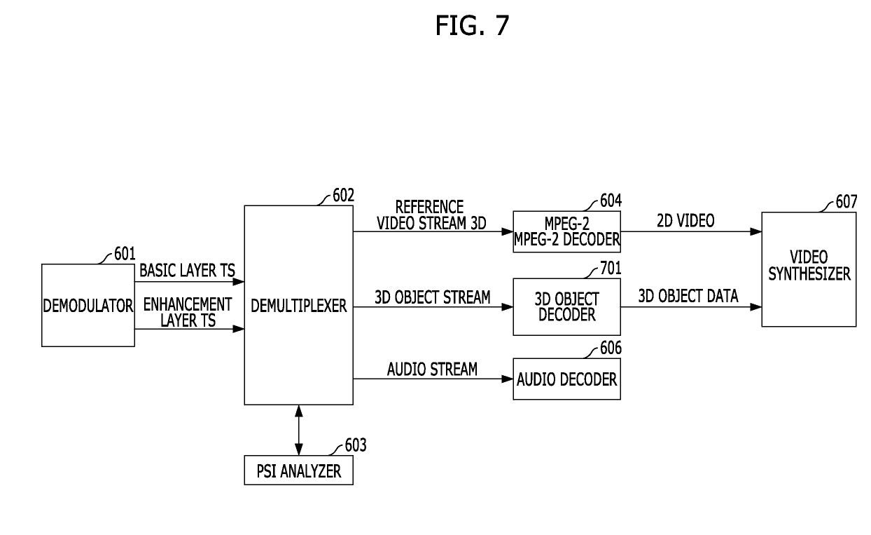

FIG. 6 is a block configuration diagram of the receiving apparatus for 3D video service according to the embodiment of the present invention and FIG. 7 shows a block configuration diagram of the receiving apparatus for 3D data service according to the embodiment of the present invention.

The receiving apparatus according to the embodiment of the present invention is operated in a reverse order of the operation of the transmitting apparatus as described above.

First, the operation of the receiving apparatus for 3D video service will be described below with reference to FIG. 6.

A demodulator 601 receives and demodulates the RF-modulated basic layer transport stream and enhancement layer transport stream. Further, the demodulator 601 transmits the demodulated basic layer transport stream and enhancement layer transport stream to the demultiplexer 602.

The basic layer transport stream includes the reference video stream, the 3D auxiliary video basic stream, the audio stream, and the PSI information. Further, the enhancement layer transport stream includes the 3D auxiliary video enhancement stream. Therefore, the demultiplexer 602 first separates the PSI stream and transmits the separated PSI stream to a PSI analyzer 603.

The PSI analyzer 603 receives the PSI stream from the demultiplexer 602 to analyze the program specific information (PSI) and transmits the analyzed results to the demultiplexer 602.

The demultiplexer 602 demultiplexes the reference video stream, the 3D auxiliary basic stream, the 3D auxiliary video enhancement stream, and the audio stream based on the program specific information when the analyzed results for the program specific information (PSI) are transmitted from the PSI analyzer 603.

In other words, the demultiplexer 602 receives the multiplexed basic layer transport stream (TS) and the enhancement layer transport stream to search the transport stream packet having the program related table (PAT) information of which the packet identifier (PID) value in the basic layer transport stream header is “0x0000” and to transmit the searched transport stream packet to the PSI analyzer 603. Thereafter, the transport stream packet (TS packet) having the program map table (PMT) information is searched from the basic layer transport stream (TS) by receiving the packet identifier Program map PID for the program number and the program map table from the PSI analyzer 603 and is transmitted to the PSI analyzer 603. In addition, the demultiplexer 602 receives the program number associated with the transport stream of the enhancement layer and the packet identifier (PID) for the program map table to search the transport stream packet having the program map table (PMT) information from the enhancement layer transport stream and to transmit the searched transport stream to the PSI analyzer 603. Thereafter, the stream type stream_type and the packet identifier elementary PID for each configuration stream of the basic layer and the enhancement layer are each received from the PSI analyzer 603 and are demultiplexed into the transport stream (the reference video stream, the 3D auxiliary video basic stream, the 3D auxiliary video enhancement stream, the audio stream) for each information.

The MPEG-2 decoder 604 performs the decoding for the reference stream transmitted from the demultiplexer. Further, the SVC decoder 605 receives and decodes the 3D auxiliary video basic stream and the 3D auxiliary video enhancement stream. Further, an audio decoder 606 decodes the audio stream input from the demultiplexer 602.

In this case, a functional unit generating the basic stream packet (PES) for each stream before each decoder 604, 605, and 606 and depacketizing the basic stream packet to generate the basic stream ES may be added. In addition, the detailed operation of each decoder 604, 605, and 606 is already known and therefore, the detailed description thereof will be omitted in the detailed description of the present invention.

A video synthesizer 607 receives the 2D video of the MPEG-2 decoder 604 and the 3D auxiliary video of the SVC decoder 605 to output the synthesized video.

Therefore, in the embodiment of the present invention, the terminal capable of decoding only the basic layer transport stream receives the general two-dimensional service, while the terminal capable of demodulating the hierarchy modulation signal and simultaneously decoding the basic layer and the enhancement layer transport stream can reproduce the high quality of 3D video.

Next, the operation of the receiving apparatus for 3D data service will be described below with reference to FIG. 7.

In the receiving apparatus of FIG. 7, the operations of the demodulator 601, the demultiplexer 602, the PSI analyzer 603, the MPEG decoder 604, and the audio decoder 606 are the same and therefore, the description thereof will be simply described.

The demodulator 601 receives and demodulates the RF-modulated basic layer transport stream and enhancement layer transport stream and transmits the demodulated basic layer transport stream and enhancement layer transport stream to the demultiplexer 602.

The basic layer transport stream includes the reference video stream, the audio stream, and the PSI information and the enhancement layer transport stream includes the 3D object stream. Therefore, the demultiplexer 602 first separates the PSI stream and transmits the separated PSI stream to a PSI analyzer 603.

The PSI analyzer 603 receives the PSI stream from the demultiplexer 602 to analyze the program specific information (PSI) and transmits the analyzed results to the demultiplexer 602.

The demultiplexer 602 demultiplexes the reference video stream, the 3D object stream, and the audio stream based on the program specific information when the analyzed results for the program specific information (PSI) are transmitted from the PSI analyzer 603.

The MPEG-2 decoder 604 performs the decoding for the reference stream transmitted from the demultiplexer. Further, a 3D object decoder 701 receives and decodes the 3D object stream. Further, an audio decoder 606 decodes the audio stream input from the demultiplexer 602.

In this case, a functional unit generating the basic stream packet (PES) for each stream before each decoder 604, 605, and 606 and depacketizing the basic stream packet to generate the basic stream ES may be added. In addition, the detailed operation of each decoder 604, 606, and 701 is already known and therefore, the detailed description thereof will be omitted in the detailed description of the present invention.

The video synthesizer 607 receives the 2D video of the MPEG-2 decoder 604 and the 3D object data of the 3D object decoder 701 to output the linked 3D object data on the two-dimensional video.

Therefore, in the embodiment of the present invention, the terminal capable of decoding only the basic layer transport stream receives the general two-dimensional service, while the terminal capable of demodulating the hierarchy modulation signal and simultaneously decoding the basic layer and the enhancement layer transport stream can reproduce the 3 dimension object data linked with the two-dimensional video on the two-dimensional video.

Meanwhile, the multi-user frame processing method according to the embodiment of the present invention can be prepared by the computer program as described above. Further, a code and a code segment configuring the program may be easily inferred by a computer programmer. In addition, the prepared program is stored in a computer-readable recording medium (information storage medium) and is read and executed by a computer, thereby implementing the method of the embodiment of the present invention. Further, the recording medium includes all the types of computer-readable recording media (tangible medium such CD, DVD and intangible media such carrier).

As set forth above, the embodiments of the present invention can provide a higher quality of the 3D video services and the 3D data services, or the like, while maintaining compatibility with the existing DTV or 3DTv services. In other words, the embodiments of the present invention can provide the high quality of 3D services while interworking with the existing base layer through the transmission channel having the low transmission rate but newly added by using the hierarchy modulation in the ATSC, or the like. In addition, the embodiments of the present invention can additionally provide the 3D data such as images, texts, graphics, or the like. In addition, the exemplary embodiments of the present invention can effectively provide the digital broadcasting services by providing the non-real time broadcasting implementing services at relatively small capacity through the enhancement layer and linking the enhancement layer with the basic layer that is being broadcast in real time.

The present invention is used to a broadcasting system for providing higher quality of 3D video services and 3D data services while maintaining compatibility with existing digital TV (DTV) or 3 dimension (3DTV) services.

While the present invention has been described with respect to the specific embodiments, it will be apparent to those skilled in the art that various changes and modifications may be made without departing from the spirit and scope of the invention as defined in the following claims.

What is claimed is:

1. A transmitting method for providing a 3 dimension television (3DTV) service relating plural transmitting layers, the transmitting method comprising:
(a) coding an input 3d video to generate a 3D auxiliary video basic stream and a 3D auxiliary video enhancement stream;
(b) generating descriptor information defining a descriptor including 3D TV service configuring information;
(c) multiplexing a coded 2D reference video stream, a coded audio stream, the coded 3D auxiliary video basic stream, and the descriptor information to transmit a reference transport stream through a basic layer; and
(d) multiplexing the 3D auxiliary video enhancement stream to transmit a 3D enhancement transport stream through the basic layer and other layers.

2. The transmitting method of claim 1, wherein a first program map table included in the reference transport stream and a second program map table included in the 3D enhancement transport stream include relationship information between programs linked with each other.

3. The transmitting method of claim 2, wherein a 3D service descriptor included in the first program map table includes an identifier value indicating the 3D service descriptor, the entire length of the 3D service descriptor, and information for distinguishing a 3D service and a 2D service from each other.

4. The transmitting method of claim 2, wherein an auxiliary service descriptor included in the second program map table includes an identifier value indicating the auxiliary service descriptor, the entire length of the auxiliary service descriptor, and information indicating a state linked with the program included in the reference transport stream.

5. The transmitting method of claim 4, wherein the information indicating the state linked with the program included in the reference transport stream includes a flag indicating the state linked with the program included in the reference transport stream and identifier information of the linked reference transport stream.

6. A transmitting method for providing a 3DTV service relating plural transmitting layers, the method comprising:
(a) generating a 3D object stream based on input object information;
(b) generating descriptor information defining a descriptor including 3DTV service configuring information;
(c) multiplexing a coded 2D reference video stream, a coded audio stream, and the descriptor information to transmit a reference transport stream through a basic layer; and
(d) multiplexing the 3D object stream to transmit a 3D object transport stream through the basic layer and other layers.

7. The transmitting method of claim 6, wherein a first program map table included in the reference transport stream and a second program map table included in the 3D object transport stream include relationship information between programs linked with each other.

8. The transmitting method of claim 7, wherein a 3D service descriptor included in the first program map table includes an identifier value indicating the 3D service descriptor, the entire length of the 3D service descriptor, and information for distinguishing a 3D service and a 2D service from each other.

9. The transmitting method of claim 7, wherein an auxiliary service descriptor included in the second program map table includes an identifier value indicating the auxiliary service descriptor, the entire length of the auxiliary service descriptor, and information indicating a state linked with the program included in the reference transport stream.

10. The transmitting method of claim 9, wherein the information indicating the state linked with the program included in the reference transport stream includes a flag indicating the state linked with the program included in the reference transport stream and identifier information of the linked reference transport stream.

11. A transmitting apparatus for providing a 3DTV service relating plural transmitting layers, the transmitting apparatus comprising:
a coder configured to code an input 3d video to generate a 3D auxiliary video basic stream and a 3D auxiliary video enhancement stream;
a descriptor information generator configured to generate descriptor information defining a descriptor including 3DTV broadcasting service configuring information; and
a multiplexer configured to multiplex a coded 2D reference video stream, a coded audio stream, the coded 3D auxiliary video basic stream, and the descriptor information to transmit a reference transport stream through a basic layer and multiplexing the 3D auxiliary video enhancement stream to transmit a 3D enhancement transport stream through the basic layer and other layers.

12. The transmitting apparatus of claim 11, wherein a first program map table included in the reference transport stream and a second program map table included in the 3D enhancement transport stream include relationship information between programs linked with each other.

13. The transmitting apparatus of claim 12, wherein a 3D service descriptor included in the first program map table includes an identifier value indicating the 3D service descriptor, the entire length of the 3D service descriptor, and information for distinguishing a 3D service and a 2D service from each other.

14. The transmitting apparatus of claim 12, wherein an auxiliary service descriptor included in the second program map table includes an identifier value indicating the auxiliary service descriptor, the entire length of the auxiliary service descriptor, and information indicating a state linked with the program included in the reference transport stream.

15. A transmitting apparatus for providing a 3DTV service relating plural transmitting layers, the transmitting apparatus comprising:
a 3D object generator configured to generate a 3D object stream based on input object information;
a descriptor information generator configured to generate descriptor information defining a descriptor including 3DTV service configuring information; and
a multiplexer configured to multiplex a coded 2D reference video stream, a coded audio stream, and the descriptor information to transmit a reference transport stream through a basic layer and multiplexing the 3D object stream to transmit a 3D object transport stream through the basic layer and other layers.

16. The transmitting apparatus of claim 15, wherein a first program map table included in the reference transport stream and a second program map table included in the 3D object transport stream include relationship information between programs linked with each other.

17. A receiving apparatus for providing a 3DTV service relating plural transmitting layers, the apparatus comprising:
a demodulator configured to demodulate a first transport stream transferred through a basic layer and a second transport stream transferred through layers different from the basic layer;
a demultiplexer configured to receive the first and second transport streams from the demodulator, demultiplex program specific information included in each of the first and second transport streams to transfer the demultiplexed program specific information to a program specific information (PSI) analyzer, and demultiplex a reference video stream, a 3D auxiliary video basic stream, and an audio stream from the first transport stream and a 3D auxiliary video enhancement stream from the second transport stream, based on an analyzing result transferred from the PSI analyzer;
a PSI analyzer configured to receive and analyze the PSI from the demultiplexer; and
a plurality of decoders configured to decode the demultiplexed reference video stream, 3D auxiliary video basic stream, 3D auxiliary video enhancement stream, and audio stream.

18. The receiving apparatus of claim 17, wherein a first program map table included in the first transport stream and a second program map table included in the second transport stream include relationship information between programs linked with each other.

19. A receiving method for providing a 3DTV service relating plural transmitting layers, the receiving method comprising:
demodulating a first transport stream transferred through a basic layer and a second transport stream transferred through layers different from the basic layer, respectively;
analyzing PSI included in each of the first and second transport streams;
demultiplexing a reference video stream, a 3D auxiliary video basic stream, and an audio stream from the first transport stream and a 3D auxiliary video enhancement stream from the second transport stream, based on an analyzing result of the PSI included in each of the first and second transport streams; and
decoding the demultiplexed reference video stream, 3D auxiliary video basic stream, 3D auxiliary video enhancement stream, and audio stream, respectively.

20. The receiving method of claim 19, wherein a first program map table included in the first transport stream and a second program map table included in the second transport stream include relationship information between programs linked with each other.

21. A receiving apparatus for providing a 3DTV service relating plural transmitting layers, the apparatus comprising:
a demodulator demodulating a first transport stream transferred through a basic layer and a second transport stream transferred through layers different from the basic layer;
a demultiplexer receiving the first and second transport streams from the demodulator, demultiplexing PSI included in each of the first and second transport streams to transfer the demultiplexed PSI to a PSI analyzer, and demultiplexing a reference video stream and an audio stream from the first transport stream and a 3D object stream from the second transport stream, based on an analyzing result transferred from the PSI analyzer;
the PSI analyzer receiving and analyzing the PSI from the demultiplexer; and
a plurality of decoders decoding the demultiplexed reference video stream, 3D object stream, and audio stream.

22. The receiving apparatus of claim 21, wherein a first program map table included in the first transport stream and a second program map table included in the second transport stream include relationship information between programs linked with each other.

23. A receiving method for providing a 3DTV service relating plural transmitting layers, the method comprising:
demodulating a first transport stream transferred through a basic layer and a second transport stream transferred through layers different from the basic layer, respectively;
analyzing PSI included in each of the first and second transport streams;
demultiplexing a reference video stream and an audio stream from the first transport stream and a 3D object stream from the second transport stream, based on an analyzing result of the PSI included in each of the first and second transport streams; and
decoding the demultiplexed reference video stream, 3D object stream, and audio stream, respectively.

24. The receiving method of claim 23, wherein a first program map table included in the first transport stream and a second program map table included in the second transport stream include relationship information between programs linked with each other.
